(19) United States
(12) Patent Application Publication
(10) Pub. No.: US 2012/0230207 A1
(43) Pub. Date: Sep. 13, 2012

(54) EARLY DETECTION OF LOSS OF CONTINUITY IN A MAINTENANCE ASSOCIATION

(75) Inventors: Yoram Stern, Ra'anana (IL); Israel Meilik, Haifa (IL)

(73) Assignee: Broadcom Corporation, Irvine, CA (US)

(21) Appl. No.: 13/041,513

(22) Filed: Mar. 7, 2011

(51) Int. Cl. H04L 12/26

(52) U.S. Cl. 370/248

(57) ABSTRACT

Systems and methods for early detection of loss of continuity in a maintenance association are provided. A method according to the invention preferably includes periodically transmitting a continuity check message (“CCM”) between two maintenance endpoints on the network. When the receiving maintenance endpoint detects a failure to receive a CCM from the transmitting maintenance endpoint for less than a standards-determined length of time, but greater than a predetermined length of time, the method may include using the receiving maintenance endpoint to implement a protection switching application in order to identify and utilize an alternate pathway for communication between the transmitting maintenance endpoint and the receiving maintenance endpoint.

### FIELD OF TECHNOLOGY

Aspects of the disclosure relate to service provider networks.

### BACKGROUND

Internet service providers typically use computers that “host” internet sessions for clients. Typically, hosting includes providing a link from a client to the internet.

Service provider networks often include multiple connections among the networks. Such connections may seem redundant, but they can help serve as an alternate path in case one of the connections break down.

It would be desirable to provide early detection of loss of continuity in a connection (alternatively referred to herein as a “path”) associated with a service provider network.

### SUMMARY OF THE INVENTION

A method for implementation of a service provider network, substantially as shown in and/or described in connection with at least one of the figures, as set forth more completely in the claims.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows a schematic diagram of a computer network for use with systems and methods according to the invention;

FIG. 2 shows an illustrative time line of the occurrence of events according to the methods of the invention; and

FIG. 3 shows a schematic diagram of an illustrative single or multi-chip module of this invention in a data processing system.

### DETAILED DESCRIPTION OF THE INVENTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

As will be appreciated by one of skill in the art upon reading the following disclosure, various aspects described herein may be embodied as a method, a data processing system, or a computer program product. Accordingly, those aspects may take the form of an entirely hardware embodiment, an entirely software embodiment or an embodiment combining software and hardware aspects. Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

Systems and methods according to the invention preferably enable a network service provider to prepare for a protection switching process—i.e., a process for switching communication paths—prior to loss of connectivity. Such a preparation according to the invention may preferably reduce network delays and improve network resiliency.

The following glossary defines certain acronyms for the purpose of this application:
LOC—Loss of Continuity
ME—Maintenance Entity
MEP—Maintenance Endpoint (which may be, for example, an outgoing port on a device). These points are at the edge of a network domain and define the boundary of the domain. An MEP sends and receives CFM frames in a relay function.
MA—Maintenance Association—A set of MEPs, all of which are configured with the same MAID (Maintenance Association Identifier) and Maintenance Domain (MD) Level, each of which is configured with an MEPID (Maintenance Endpoint Identifier) unique within that MAID and MD Level, and all of which are configured with the complete list of MEPIDs.
MIP—Maintenance Intermediate Point—these points are internal to a domain, and not at a boundary. CFM frames received from MEPs and MIPs may be catalogued and forwarded.
CCM—Continuity Check Message—“heart beat” messages for Connectivity Fault Management (“CFM”). These messages provide a means to detect connectivity failures in a set of MEPs. These messages are typically unidirectional and do not solicit a response. Each MEP transmits a periodic multicast CCM inward towards other MEPs.

Operations, Administration, and Management (“OAM”) is a set of protocols/processes used for network fault management and performance monitoring. OAM is set forth in Standards ITU-T service OAM (Operations, Administration and Maintenance) Standards Y.1731/IEEE 802.1ag, which are incorporated herein by reference in their respective entireties. Y.1731 is similar to IEEE 802.1ag in that it divides a network into hierarchical maintenance domains. Both standards further define constituent maintenance points and the managed objects required to create and administer them. Further, the standards describe the protocols and procedures used by maintenance points to maintain and diagnose connectivity faults within a maintenance domain.

Specifically, standards ITU-T Y.1731/IEEE 802.1ag define the following mechanism to detect loss of continuity between MEPs:

Each of the MEPs sends a CCM message to preferably all neighbors every T milliseconds (ms).

If the endpoint detects a period of 3.5T without receiving valid CCM message from a neighbor, then it declares loss-of-continuity (“LOC”) with that neighbor.

If the endpoint measures delays that are relatively large delays (for example 2.5T) but that are not large enough to implicate the standard for declaring an LOC, the standards do not define an alarm.

Systems and methods according to the invention preferably transmit a signal to the network operator when the continuity to a specific neighbor is “almost lost”—i.e., when the delays between two MEPs are large enough to indicate an impending loss of continuity but do not implicate the delay set forth in the standard. Accordingly, such a feature may allow an operator to detect connectivity problems between endpoints at a point in time that is earlier than that provided by the standard.

Such a feature may be implemented, either automatically or to signal an operator, in order to reroute traffic prior to an actual declaring of an LOC. In certain embodiments, such a feature may be implemented to take steps to prepare an alternative traffic route, yet not actually change the traffic route prior to a standards-implicated declaration of LOC.

In some embodiments, the detected deficiency in connectivity might be false. Preferably, systems and methods according to the invention may respond to false positive tests by providing a configuration register that allows an operator to selectively disable detection of connectivity problems between endpoints at a point in time that is earlier than the standard allows.

In conventional provider networks, an MEP periodically transmits a multicast CCM in order to ensure continuity over the maintenance association to which the transmitting MEP belongs.

The CCM is catalogued by MIPs and terminated by remote MEPs in the same MA.

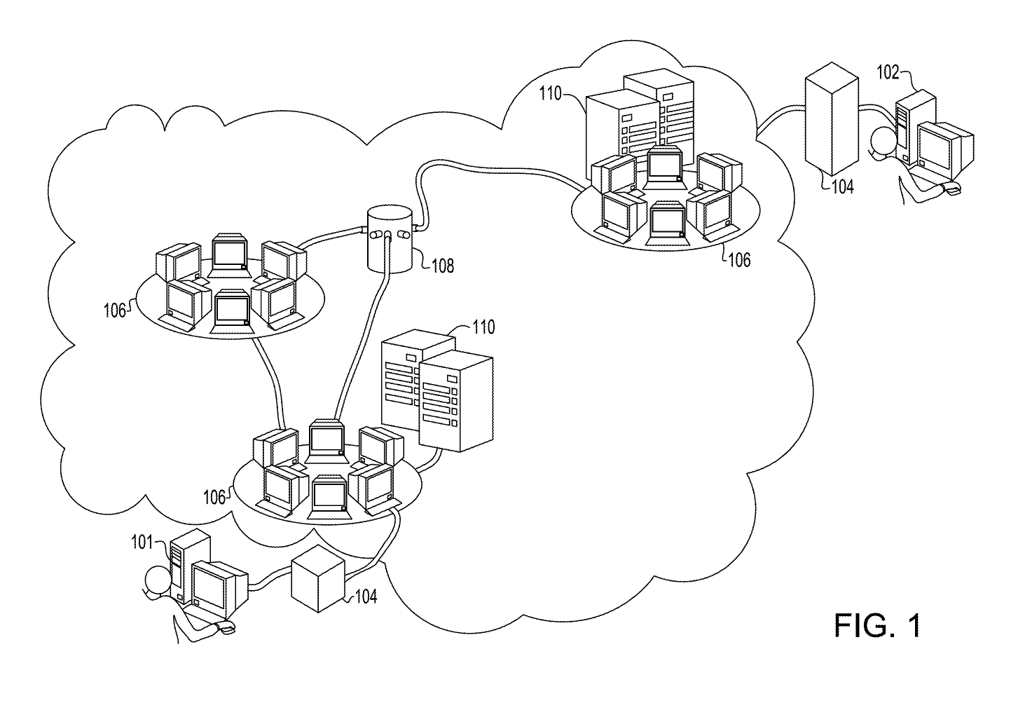

FIG. 1 shows a schematic diagram of a computer network for use with systems and methods according to the invention. A user 102 is shown connected to a network via a telephone switch 104 (which could also be any other suitable communication medium such as a cable, fiber, Ethernet, etc.). Typically, the user connects to telephone switch 104.

Telephone switch 104 couples the user to the internet service provider host computers 106. The host computers, which together may form an internet service provider network that hosts the internet session, provide a link to the internet. Each internet service provider may have local servers 110 set aside exclusively for its own network. Such servers may support functions such as mail, newsgroups and proxy, which delivers pages to the user. Other internet service provider networks may be connected to one another, each with its own servers and/or supercomputers.

Routers 108 direct internet traffic. Typically, routers 108 determine the best path for traffic to take.

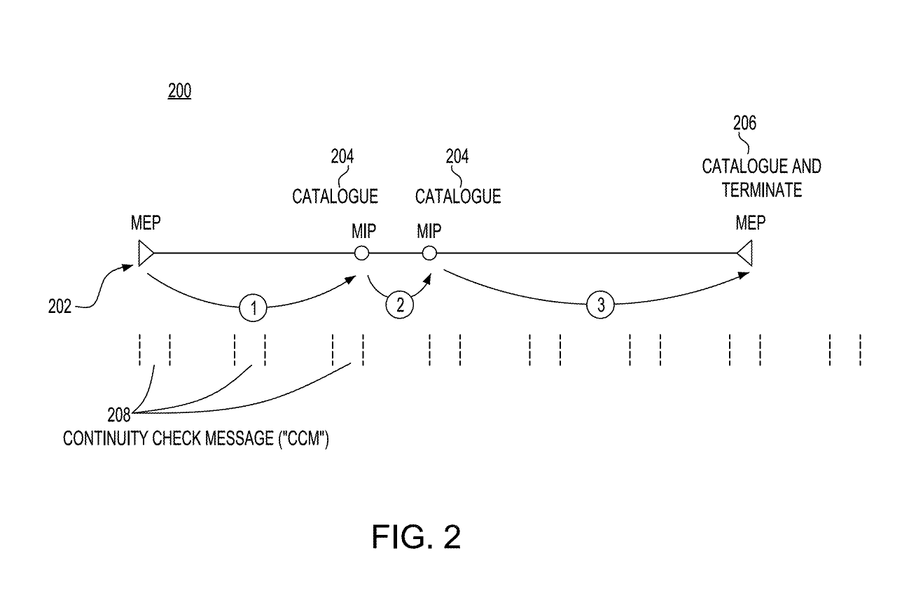

FIG. 2 shows an illustrative time line 200 of selected events according to the invention. MEP 202 (which may be understood to be one of the computers in an internet provider network, as shown in FIG. 1) preferably periodically transmits multicasts—i.e., transmits to more than one member of a larger network—a CCM 208. CCM 208 preferably ensures continuity by allowing the receiving endpoints to detect connectivity failures among the members of the maintenance association to which the transmitting MEP 202 belongs.

The CCM is catalogued by MIPs 204 and terminated by remote MEPs 206 in the same maintenance association.

CCM frames 208 are shown schematically at the bottom of FIG. 208 to indicate a communication “heart beat” signal between two or more MEPs 202. A receiving MEP 206 may detect an LOC with another MEP 202 when it stops receiving, for a predetermined period of time, CCM frames 208 from that MEP 202. Such a defect condition can be caused by hardware failures—e.g., a link failure, a device failure, or the like. Such a defect condition can be cause by software failures—e.g., memory corruption, mis-configurations, or the like.

In the aforementioned standards, LOC state entry criteria can be that an MEP receives no CCM frames from a peer MEP during an interval equal to 3.5 times the CCM transmission period.

The shortest CCM transmission period is defined in the aforementioned standards as 3.33 milliseconds. Thus, under current standards, an MEP has to wait at least about 11.666 milliseconds before entering an LOC state. It should be noted that the invention applies to any suitable standards-set CCM transmission period, or to any other suitable transmission period.

Systems and methods according to the invention support entering an LOC state prior to the amount of time required by the aforementioned standard (or other appropriate standard), or at least preparing to enter an LOC state prior to the amount of time required by the standard. Utilization of such systems and methods preferably reduces switching delay related to entering an LOC state.

Systems and methods according to the invention may preferably transmit a signal to a network provider and/or a network provider operator of the elapse of a significant, preferably predetermined, time period between CCMs, where such time period is not enough to trigger an LOC state. Such an elapse of time is not part of the standard. Nevertheless, such early LOC notification information may be used by the network provider to reduce delay and improve network resiliency.

In one exemplary scenario of the operation of systems and methods according to the invention, an MEP, such as MEP 206 shown in FIG. 2, may experience periods of 10 milliseconds without receiving CCM frames from a peer MEP. In such a circumstance, the standard clearly states that no LOC state is registered.

Nevertheless, it may be beneficial for systems and methods associated with the network provider for MEP 206 to trigger an application that either 1) prepares to switch from one pathway to a different pathway; or 2) triggers a protection switching application.

Such a preparatory application, as set forth in 1) above, may preferably pre-set the conditions necessary to switch from one pathway to a different pathway—e.g., identifying the alternate pathway prior to the elapsing of about 11.66 seconds or other suitable amount of time. Such anticipatory identifying of an alternate pathway may preferably reduce the implementation time of the protection switching application. Such a triggering application, as set forth in 2) above, actually switches communication between MEP 206 and one or more other MEPs in a maintenance association to a different pathway(s) for transmitting packets—prior to the shift to the standard LOC state.

Identifying of an alternate pathway, pursuant to 1) above, may include identifying other computers (such as computers 106 shown in FIG. 1), routers (such as routers 108 shown in FIG. 1), and/or servers 210 (such as servers 210 shown in FIG. 1) through which to route communication to the MEP that has detected a substantial, but less than the standard, amount of time since the last CCM.

In certain embodiments of the invention, embodiments of the invention may preferably notify members of the MA that impending connectivity failures are associated with a particular ME and that the members of the MA should be on alert status for connectivity failures associated with the particular ME. Such alert status may define an even lower threshold of either preparing to switch from one pathway to a different pathway or triggering a protection switching application with respect to the failing ME.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

Aspects of the invention have been described in terms of illustrative embodiments thereof. A person having ordinary skill in the art will appreciate that numerous additional embodiments, modifications, and variations may exist that remain within the scope and spirit of the appended claims. For example, one of ordinary skill in the art will appreciate that the steps illustrated in the figures may be performed in other than the recited order and that one or more steps illustrated may be optional. The methods and systems of the above-referenced embodiments may also include other additional elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

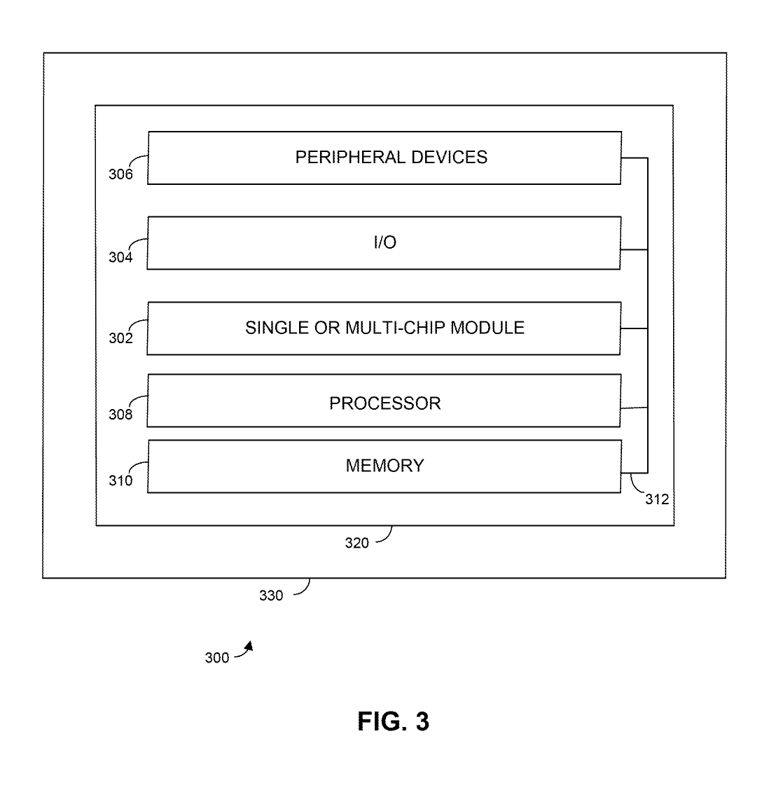

FIG. 3 shows a single or multi-chip module 306 according to the invention, which can be one or more integrated circuits, in an illustrative data processing system 300 according to the invention. Data processing system 300 may include one or more of the following components: peripheral devices 302, I/O circuitry 304, multiple processing cores 308 and memory 310.

These components are coupled together by a system bus or other interconnections 312 and are populated on a circuit board 316 which is contained in an end-user system 318. System 300 is configured for use in a mobile phone according to the invention. While system 300 represents a generic embedded device with multiple processing cores which, according to the invention can use a hypervisor to wake a single processor for idle tasks, nevertheless, it should be noted that system 300 is only exemplary, and that the true scope and spirit of the invention should be indicated by the following claims.

Thus, systems and methods for early detection of loss of continuity according to the invention have been provided. Persons skilled in the art will appreciate that the present invention can be practiced by other than the described embodiments, which are presented for purposes of illustration rather than of limitation, and the present invention is limited only by the claims which follow.

What is claimed is:

1. A network comprising a maintenance association, said maintenance association comprising a plurality of maintenance endpoints;
wherein each maintenance endpoint periodically transmits a continuity check message (“CCM”) to at least a portion of the plurality of the maintenance endpoints in order to detect connectivity failures between maintenance endpoints, said connectivity failures being characterized at least by a failure by a maintenance endpoint to receive a CCM from a peer maintenance endpoint for a standards-determined length of time, and wherein each maintenance endpoint is further configured to determine an alternate pathway for communication with the maintenance association in response to failing to receive a CCM for an amount of time that is less than the standards-determined length of time.

2. The network of claim 1 wherein the amount of time that is less than the standards-determined length of time comprises a magnitude that is less than the standards-determined length of time by at least 10% of the magnitude of the standards-determined length of time.

3. The network of claim 1 further comprising a plurality of maintenance endpoints, said plurality of maintenance endpoints providing network nodes in between two maintenance endpoints, wherein each of the maintenance intermediate points is configured to catalogue a CCM upon receipt.

4. The network of claim 1 wherein each of the maintenance endpoints is configured to catalogue and terminate a CCM upon receipt.

5. The network of claim 1 wherein each of the maintenance endpoints is configured to determine a loss of continuity between the maintenance endpoint and a peer maintenance upon failing to receive a CCM from the peer maintenance endpoint for the standards-determined amount of time.

6. The network of claim 1 wherein the standards-determined amount of time comprises an amount of time determined by either one or both of standards ITU-T Y.1731 or IEEE 802.1ag.

7. The network of claim 1 wherein the standards-determined length of time is about 11.655 milliseconds.

8. One or more computer-readable media storing computer-executable instructions which, when executed by a processor on a computer system, perform a method, the method for operating a network to reduce negative effects of connectivity failures, the method comprising:
periodically receiving a continuity check message (“CCM”) from a first one of a plurality of maintenance endpoints on the network;
when the receiving maintenance endpoint detects a failure to receive a CCM from the transmitting maintenance endpoint for a standards-determined length of time, using the receiving maintenance endpoint to declare a loss of continuity with respect to the transmitting maintenance endpoint; and,
when the receiving maintenance endpoint detects a failure to receive a CCM from the transmitting maintenance endpoint for less than a standards-determined length of time, but greater than a predetermined length of time, using the receiving maintenance endpoint to determine an alternate pathway for communication between the transmitting maintenance endpoint and the receiving maintenance endpoint.

9. The method of claim 8 wherein the standards-determined minimum length of time is about 11.666 milliseconds.

10. The method of claim 8 further comprising using the receiving maintenance endpoint to catalogue and terminate a CCM upon receipt.

11. The method of claim 8 wherein the standards-determined amount of time comprises an amount of time determined by either one or both of standards ITU-T Y.1731 or IEEE 802.1ag.

12. A network comprising a maintenance association, said maintenance association comprising a plurality of maintenance endpoints; and
wherein:
each maintenance endpoint periodically transmits a continuity check message (“CCM”) to at least a portion of the plurality of the maintenance endpoints in order to detect connectivity failures between maintenance endpoints, each of said connectivity failure being characterized by a failure by a receiving maintenance endpoint to receive a CCM from a transmitting maintenance endpoint for a standards-determined length of time; and
each receiving maintenance endpoint is configured to trigger a protection switching application to implement an alternate pathway for communication with the transmitting maintenance endpoint from which the receiving endpoint failed to receive a CCM for an amount of time that is less than a standards-determined length of time.

13. The network of claim 12 wherein the amount of time that is less than the standards-determined length of time comprises a magnitude that is less than the standards-determined length of time by at least 10% of the magnitude of the standards-determined length of time.

14. The network of claim 12 wherein the CCM message is transmitted from one maintenance endpoint to another maintenance endpoint via a maintenance intermediate point.

15. The network of claim 12 wherein each of the maintenance endpoints is configured to catalogue and terminate a CCM upon receipt.

16. The network of claim 12 wherein each of the maintenance endpoints is configured to determine a loss of continuity between the maintenance endpoint and a peer maintenance upon failing to receive a CCM from the peer maintenance endpoint for the standards-determined amount of time.

17. The network of claim 12 wherein the standards-determined amount of time comprises an amount of time determined by either one or both of standards ITU-T Y.1731 or IEEE 802.1ag.

18. The network of claim 12 wherein the standards-determined minimum length of time is about 11.666 milliseconds.

19. One or more computer-readable media storing computer-executable instructions which, when executed by a processor on a computer system, perform a method, the method for operating a network to reduce negative effects of connectivity failures, the method comprising:
periodically transmitting a continuity check message (“CCM”) between two maintenance endpoints on the network; and
when the receiving maintenance endpoint detects a failure to receive a CCM from the transmitting maintenance endpoint for less than a standards-determined length of time, but greater than a predetermined length of time, using the receiving maintenance endpoint to implement a protection switching application in order to identify and utilize an alternate pathway for communication between the transmitting maintenance endpoint and the receiving maintenance endpoint.

20. The method of claim 19 wherein the standards-determined minimum length of time is about 11.666 milliseconds.

21. The method of claim 19 further comprising using the receiving maintenance endpoint to catalogue and terminate a CCM upon receipt.

22. The method of claim 19 wherein the standards-determined amount of time comprises an amount of time determined by either one or both of standards ITU-T Y.1731 or IEEE 802.1ag.
